(19) United States
(12) Patent Application Publication
(10) Pub. No.: US 2018/0180549 A1
(43) Pub. Date: Jun. 28, 2018

(54) Raman Spectroscopic Structure Investigation of Proteins Dispersed in a Liquid Phase

(71) Applicant: MALVERN INSTRUMENTS LTD., Worcestershire (GB)

(72) Inventor: E. Neil Lewis, Olney, MD (US)

(21) Appl. No.: 15/128,631

(22) PCT Filed: Mar. 25, 2015
(86) PCT No.: PCT/GB2015/050892

§ 371 Date: Sep. 23, 2016

Related U.S. Application Data
(60) Provisional application No. 62/026,563, filed on Jul. 18, 2014.
(60) Provisional application No. 61/970,198, filed on Mar. 25, 2014.

(51) Int. Cl. G01N 21/65; G01N 11/02

(52) U.S. Cl. CPC G01N 21/65; G01N 2011/008; G01N 11/02

(57) ABSTRACT

A method of Raman spectroscopic structure investigation of a sample that includes a dispersed chemical species, in particular a protein, in a liquid phase and an apparatus for performing said method are described. The method comprises: providing the sample; providing marker particles in the sample; exciting the sample with a light source; receiving Raman-scattered light from the dispersed chemical species in the sample; detecting, from the received Raman-scattered light, Raman scattering from the dispersed chemical species in the sample; detecting movement of the marker particles in the sample; and extracting at least one characteristic of the dispersed chemical species in the sample from both the step of detecting Raman scattering and the step of detecting movement of the particles.

This application is related to U.S. Provisional Application No. 61/970,198, filed Mar. 25, 2014 and No. 62/026,563, filed Jul. 18, 2014, which are both herein incorporated by reference.

### FIELD OF THE INVENTION

The invention relates to spectrometry, including the use of Raman spectrometry to investigate protein structure.

### BACKGROUND OF THE INVENTION

Since the introduction of the first biotherapeutic, recombinant human insulin, developed by Genentech in 1978 and commercialized as Humulin by Eli Lilly and Company in 1982, more than 130 unique products have been commercialized. These medicines, whose active ingredients are proteins (i.e., growth hormone, antibodies, insulin) are produced by living cells (i.e., cells, viruses and bacteria) and used to treat and prevent life threatening illnesses such as cancer, multiple sclerosis, rheumatoid arthritis, diabetes and heart disease.

The annual revenue for biopharmaceuticals has been consistently growing since 2001, accounting for 15.6% of the total pharmaceutical market in 2011. The global biopharmaceutical market was valued at $138 billion in 2011 and is expected to grow to over $320 billion by 2020. (GBI Research) This growth is expected to come from the launch of new products, the approval of new indications for existing products, and the growth of the global biosimilar market (projected to reach $9 billion by 2020).

The drive for better analytical tools in the biotherapeutics industry is focused on a number of areas namely the creation of new molecular entities (drug discovery) product development (pre-formulation and formulation) and manufacturing/quality control (bio-fermentation and bio-processing). The differences in the analytical testing requirements for biotherapeutics versus the traditional ‘small molecule’ solid-dosage market are profound, and both the pharmaceutical industry and the regulators are actively searching for technologies that can address these new and challenging measurement requirements.

The pace of development of new structural entities continues to accelerate, with more than 5000 currently in the biopharmaceutical development pipeline. (phRMA) This number includes vaccines and monoclonal antibodies (mAbs), which account for the majority of products currently entering the market, as well as “next generation” entities such as dual variable domain antibodies (DVDs), antibody drug conjugates (ADCs) and protein fragments or small peptides. For drug product development, it is important to improve understanding of the structure/function/efficacy relationship and identify features/issues as early as possible in the drug product lifecycle to avoid poor product attributes at later development stages that are costly or impossible to remedy. As a result, there is an increasing demand for new analytical technologies and the ‘repurposing’ of existing technologies to accelerate product development.

On the manufacturing side, in contrast to small-molecule drug entities that are created via chemical synthesis, biotherapeutics are manufactured using complex living systems that tend to be very sensitive to environmental conditions. As even subtle changes in manufacturing can alter the final product, there is a need to understand “critical to quality attributes”, and to have the appropriate analytical tools to maintain and control safety and efficacy of biotherapeutics throughout the entire process. As the number of therapeutic proteins entering the pharmaceutical portfolio and product development pipeline continues to increase, the development and validation of analytical methods to address the requirements for their characterization has not kept pace.

A problem outlined by Amin et al, in “Protein aggregation, particle formation, characterization and rheology”, Current Opinion in Colloid & Interface Science, Vol. 19, Issue 5, October 2014, pp 438-449, is that there are currently no protein-specific molecular theories for the composition dependence of viscosity of stable proteins in solution, and the rheology of irreversibly aggregating systems is complicated. Measurements on such solutions can therefore be challenging.

It is an object of the invention to address one or more of the above mentioned problems.

### SUMMARY OF THE INVENTION

In accordance with a first aspect of the invention there is provided a method of spectroscopic structure investigation of a sample that includes a dispersed chemical species in a liquid phase, the method comprising:

providing the sample;

providing marker particles in the sample;

exciting the sample with a light source, for example a narrow-band light source such as a laser;

receiving Raman-scattered light from the dispersed chemical species in the sample;

detecting, from the received Raman-scattered light, Raman scattering from the dispersed chemical species in the sample;

detecting movement of the marker particles in the sample; and

extracting at least one characteristic of the dispersed chemical species in the sample from both the step of detecting Raman scattering and the step of detecting movement of the particles.

In an alternative aspect, the method may alternatively comprise:
providing the sample;
exciting the sample with a light source, for example a narrow-band light source such as a laser;
receiving Raman-scattered light from the dispersed chemical species in the sample;
detecting, from the received Raman-scattered light, Raman scattering from the dispersed chemical species in the sample;
measuring viscosity of the sample; and
extracting at least one characteristic of the dispersed chemical species in the sample from both the step of detecting Raman scattering and the step of measuring viscosity.

Measuring viscosity may be done by detecting movement of marker particles in the sample, or may be done in other ways such as by capillary flow measurement.

The liquid sample within which the chemical sample is dispersed is preferably continuous.

The step of providing the dispersed sample may involve providing a protein sample.

The step of detecting may involve detecting Raman scattering that is located outside of a characteristic fingerprint spectral feature region for the protein in the sample, wherein the step of extracting extracts the at least one characteristic of the protein in the sample from the step of detecting Raman scattering that is located outside of the characteristic fingerprint spectral region.

The step of extracting may identify at least one structural feature associated with the dispersed chemical species in the sample.

The step of detecting Raman scattering may detect frequencies within a spectral feature range of between about 0 and 400 cm⁻¹.

The step of extracting may identify at least one feature associated with:
a solvent in the sample;
an aqueous solvent in the sample;
hydrogen bonding in the sample;
solvent-protein interactions in the sample;
water-protein interactions in the sample; and/or
sample changes in the mesoscale size range in the sample.

The method may further include the step of determining a quality control measure for a protein or a measure of stability of a protein based on results of the step of detecting.

The method may further include the step of modifying a protein based on results of the step of detecting.

The method may further include the step of filtering out a single spectral feature pass band from the received Raman-scattered light in the step of receiving, and wherein the step of detecting is performed by measuring energy within a pass band. The pass band may have a width that exceeds about 10 cm⁻¹.

The method may further include the step of filtering out a plurality of spectral feature pass bands from the received Raman-scattered light in the step of receiving, and wherein the step of detecting is performed by measuring energy within each of the pass bands.

The steps of exciting, receiving, and detecting may be performed for a plurality of different conditions, such as a plurality of different temperatures, a plurality of different pH levels and/or a plurality of different ionic strengths.

The step of extracting may identify at least one feature associated with:
protein structure in the sample;
mesoscale structure in the sample;
glycosylation in the sample;
pegylation in the sample;
deamidation in the sample;
oxidation in the sample;
protein networks in the sample;
sample aggregation in the sample;
protein charge in the sample;
protein rheology in the sample;
protein dipoles in the sample;
protein viscosity in the sample;
protein binding in the sample;
changes in a protein associated with ionic strength in the sample; and/or
changes in a protein associated with solvent pH in the sample.

The step of providing may involve providing a dispersed chemical species that includes one or more of a suspended or dissolved macromolecule sample, a suspended nanomaterial sample, and a suspended nanoparticulate sample.

The method may further include the step of providing a model, for example a multivariate model, that associates Raman spectra of the chemical species with rheological properties of the chemical species, and extracting at least one characteristic of a sample of the chemical species from application of the model to results of a further step of detecting Raman scattering.

In accordance with a second aspect of the invention there is provided an apparatus for spectroscopic sample structure investigation for a sample that includes a dispersed chemical species in a liquid phase, the apparatus comprising:
a sample holder, such as a cuvette, for holding the sample;
a plurality of marker particles for mixing with the sample held by the sample holder;
a laser source for exciting the sample held by the sample holder;
a particle motion detector positioned to detect motion of the plurality of marker particles in the sample held by the sample holder; and
a Raman detector positioned to receive Raman-scattered radiation from the sample resulting from excitation by the laser source.

In accordance with a third aspect of the invention there is provided an apparatus for spectroscopic sample structure investigation for a sample that includes a dispersed protein species in a liquid phase, the apparatus comprising:
means for holding the sample;
means for exciting the sample with a light source, for example a narrow-band light source such as a laser
means for receiving Raman-scattered light from the sample;
means for detecting, from the received Raman-scattered light, Raman scattering from the dispersed protein species in the sample;
means for detecting movement of marker particles in the sample; and
means for extracting at least one characteristic of the dispersed protein species in the sample from both the means for detecting Raman scattering and the means for detecting movement of the marker particles.

In an alternative aspect, the apparatus according to the second or third aspect may comprise:
a sample holder for holding the sample;
a laser source for exciting the sample held by the sample holder; and
a Raman detector positioned to receive Raman-scattered radiation from the sample resulting from excitation by the laser source,
wherein the sample holder is a capillary tube and the apparatus is configured to measure viscosity of the sample by measurement of capillary flow through the sample holder.

The apparatus of the second or third aspects may further include rheological information extraction logic responsive to the particle motion detector, and spectral information extraction logic responsive to the Raman detector.

The apparatus may further include information extraction logic responsive both to the particle motion detector and to the Raman detector.

The apparatus may further include protein characteristics extraction logic responsive both to the particle motion detector and to the Raman detector.

The particle motion detector may include an optical fiber coupled to an optical detector.

The sample holder, or cuvette, may include an unmarked sample volume and a marked sample volume separated by a partition that is permeable to the sample but not the particle marker particles.

The partition may define the marked sample volume as a closed volume, which may for example define a sphere.

The particle motion detector may include an optical fiber coupled to an optical detector at one of its ends and being directed towards the marked sample volume at its other end.

The Raman detector may have a detection spectral feature range for Raman scattering that is lower in frequency than a characteristic fingerprint spectral feature region for the dispersed chemical species in the sample.

The Raman detector may be operative to detect frequencies within a spectral feature range of between about 0 and 400 cm⁻¹.

The sample holder may be for a dispersed chemical species that includes one or more of a suspended or dissolved macromolecule sample, a suspended nanomaterial sample, and a suspended nanoparticulate sample, and wherein the a Raman detector that has a detection spectral feature range for Raman scattering that is lower in frequency than a characteristic fingerprint spectral feature region for the one or more dispersed chemical species in the sample.

The apparatus may further include spectral identification logic operative to detect spectral features associated with predetermined characteristics of the sample. The spectral identification logic may be operative to:
detect at least one spectral feature associated with solvent-solute interactions;
detect at least one spectral feature associated with solute-solute interactions; and/or
identify at least one spectral feature associated with hydrogen bonding in the sample.

The particle motion detector may be positioned to detect scattering of light from the laser source in the sample.

The apparatus may further include a further laser source, wherein the particle motion detector is positioned to detect scattering of light from the further laser source in the sample.

The sample holder may be for a protein sample and the detector may have a detection spectral range for Raman scattering that is lower in frequency than a characteristic fingerprint spectral region for the protein sample.

The apparatus may further include spectral identification logic operative to detect spectral features associated with predetermined characteristics of the protein sample.

The spectral identification logic may include at least one of multivariate spectral analysis logic, spectral component analysis logic, and spectral library comparison logic.

The spectral identification logic may be operative to identify at least one spectral feature associated with:
a dispersed chemical species in the sample;
a protein in the sample;
a solvent in the sample;
an aqueous solvent in the sample;
hydrogen bonding in the sample;
solvent-protein interactions in the sample;
water-protein interactions in the sample;
changes in ionic strength in the sample;
changes in pH in the sample; and/or
mesoscale effects in the sample.

The apparatus may further include logic for determining:
a measure of stability of the dispersed chemical species responsive to the Raman detector;
a measure of stability of the protein responsive to the Raman detector; and/or
a quality control measure responsive to the Raman detector.

The apparatus may further include a single spectral feature band-pass filter located in an optical path between the sample and the Raman detector, and wherein the Raman detector is operative to measure an amount of energy in the pass band of the filter that includes information about one of the predetermined characteristics.

The detector may be operative to detect a pass band with a width that exceeds about 10 cm⁻¹.

The apparatus may further include a plurality of spectral feature band-pass filters each located in an optical path between the sample and the Raman detector, and wherein the Raman detector is operative to measure an amount of energy in each of the pass bands of the filters that includes information about one of the predetermined characteristics.

The Raman detector may include an array detector or an FT-Raman detector.

The apparatus may further include a protein property detector of a further type, such as a light scattering detector or a protein concentration detector.

The spectral identification logic may be operative to identify at least one spectral feature associated with protein structure or protein concentration in the sample.

The apparatus may further include a stored machine-readable model that associates Raman spectra of dispersed chemical species with at least one rheological property of the dispersed chemical species, and prediction logic responsive to the stored machine-readable model and to an output of the Raman detector to derive at least one predicted rheological property value for the sample in the sample holder.

In accordance with a fourth aspect of the invention there is provided a method of spectroscopic structure investigation for a sample that includes a dispersed chemical species in a liquid phase, comprising:
providing the dispersed chemical sample in the liquid phase;
providing a model that associates Raman spectra of a dispersed sample with one or more properties of the dispersed sample;
exciting the dispersed chemical species in the liquid phase with a light source, for example a narrow-band light source such as a laser;
receiving Raman-scattered light from the dispersed chemical species;
detecting, from the received Raman-scattered light, Raman scattering from the dispersed chemical species; and
extracting a property of the sample from application of the model to results of the step of detecting Raman scattering.

An advantage of the invention is that measurements on dispersed chemical species, such as proteins, can be made without the need to contaminate the sample with other species such as marker particles to obtain a measure of a desired property of the sample using Raman scattering. This is particularly advantageous when samples may be very limited in size and availability, such as in the case of experimental drug compounds. The use of probe or marker particles can also affect the properties of such samples, so avoiding their use should enable a more accurate measure of the actual sample properties.

The liquid sample within which the chemical sample is dispersed is preferably continuous.

The one or more properties in the multivariate model may include concentration, temperature and/or viscosity of the dispersed sample. The viscosity may be a complex viscosity.

The model may be a multivariate model, and may be a partial least squares regression model.

The method may further include the step of extracting information about chemical characteristics of the sample from the model, in particular from loadings in the model. The step of extracting information from the model may involve extracting information about which spectral regions are associated with rheometric properties of the sample.

The property of the sample may be extracted using a portion of a spectrum of the received Raman scattered light within the range of 100 to 300 cm⁻¹

In accordance with a fifth aspect of the invention there is provided an apparatus for spectroscopic structure investigation of a sample that includes a dispersed chemical species in a liquid phase, the apparatus comprising:
a sample holder, such as a cuvette, for holding the dispersed chemical species in the liquid phase;
a stored machine-readable model that associates Raman spectra of the dispersed chemical sample with at least one rheological property of the dispersed chemical species;
a laser source for exciting the sample held by the sample holder;
a Raman detector positioned to receive Raman-scattered radiation from the sample resulting from excitation by the laser source; and
prediction logic responsive to the stored machine-readable model and to an output of the Raman detector to derive at least a property of the sample from the received Raman-scattered radiation using the model.

In accordance with a sixth aspect of the invention there is provided an apparatus for spectroscopic structure investigation of a sample that includes a dispersed chemical species in a liquid phase, the apparatus comprising:
means for holding the dispersed sample in the liquid phase;
means for storing a model that associates Raman spectra of the dispersed chemical sample with rheological properties of the dispersed chemical sample;
means for exciting the dispersed chemical species in the sample with a light source, for example a narrow-band light source such as a laser;

means for receiving Raman-scattered light from the dispersed chemical species in the sample;

means for detecting, from the received Raman-scattered light, Raman scattering from the dispersed chemical species in the sample; and
means for extracting at least one characteristic of the dispersed chemical species in the sample from both the means for detecting Raman scattering and the means for storing the model.

The liquid sample within which the chemical sample is dispersed is preferably continuous.

The one or more properties in the model, which may be a multivariate model, may include concentration, temperature and/or viscosity of the dispersed sample.

The model may be a partial least squares regression model.

The prediction logic may be configured to extract information about chemical characteristics of the sample from the model, in particular from loadings in the model.

The predictive logic may be configured to extract information about which spectral regions are associated with rheometric properties of the sample. The predictive logic may be configured to extract the property of the sample using a portion of a spectrum of the received Raman scattered light within the range of 100 to 300 cm⁻¹.

### BRIEF DESCRIPTION OF THE DRAWINGS

FIG. 1 is a block diagram of an exemplary particle measurement system;

FIG. 2a is a plot of Raman spectra of a sample of bovine serum albumen (BSA) in phosphate buffered saline (PBS) in the Amide I region as a function of concentration;

FIG. 2b is plot of concentration versus intensity of peak at about 1650 cm⁻¹;

FIG. 2c is a plot of normalized second derivative spectra of the amide I region at six concentrations;

FIG. 2d is a plot of the second derivative of the low frequency 100-250 cm⁻¹ portion of the spectrum as a function of concentration;

FIG. 2e is a plot of peak position as a function of concentration, with data from the second derivative spectra in FIG. 2d;

FIG. 3a is a plot of principal component analysis scores of the Amide I region (1600-1800 cm⁻¹) of Raman spectra of BSA at three different pH conditions;

FIG. 3b is a plot of principal component scores as a function of temperature derived from the low frequency region (100-300 cm⁻¹) of the Raman spectra of BSA at three different pH conditions;

FIG. 4a is a plot of spectra of lysozyme solutions in the Amide I region at 20° C., 80° C. and again at 20° C.;

FIG. 4b is a plot of peak position of the Amide I as a function of the up and down temperature ramp;

FIG. 4c is a plot of spectra of the same lysozyme sample in the low frequency region upon heating and cooling at 20° C., 80° C. and then again at 20° C.; FIG. 4d is a plot showing the temperature dependence of the spectra in FIG. 4c showing a frequency shift at 152 cm^{-1;}

FIG. 5a is a plot of the spectra of human serum albumin (HSA) below (T−) and above (T+) unfolding temperature Tm in the Amide I region;

FIG. 5b is a plot of low frequency spectra (80-280 cm⁻¹) of the same sample below (T−) and above (T+) unfolding temperature Tm;

FIG. 5c is a plot of spectra of HSA treated with H₂O₂ (oxidizer), shown below (T−) and above (T+) Tm as in FIG. 5a;

FIG. 5d is a plot of low frequency spectra (60-220 cm⁻¹) of the H₂O₂ treated sample, shown below (T−) and above (T+) Tm as in FIG. 5a;

FIG. 6 is a plot of second derivative Raman spectra of a solution of a monoclonal antibody at 20° C. (T−) and 80C (T+) temperature;

FIG. 7 is a diagrammatic illustration of a first probe for use in the system of FIG. 1 that employs marker particles;

FIG. 8 is a diagrammatic illustration of a second probe for use in the system of FIG. 1 that employs marker particles;

FIG. 9 is a diagrammatic illustration of a third probe for use in the system of FIG. 1 that employs marker particles;

FIG. 10 is a diagrammatic illustration of a fourth probe for use in the system of FIG. 1 that employs marker particles;

FIG. 11 is a plot of the first three loadings for a four-factor model derived for data acquired using the system of FIG. 1;

FIG. 12 is a plot of viscosity predicted by the four-factor model against measured viscosity for the sample and model referenced in connection with FIG. 11;

FIG. 13 is a plot of temperature predicted by the four-factor model against measured temperature for the sample and model referenced in connection with FIG. 11;

FIG. 14 is a plot of concentration predicted by the four-factor model against measured concentration for the sample and model referenced in connection with FIG. 11;

FIG. 15 is a block diagram of an implementation of the system of FIG. 1; and

FIG. 16 is a block diagram of a variant of the system of FIG. 1 that employs a multivariate model.

### DETAILED DESCRIPTION

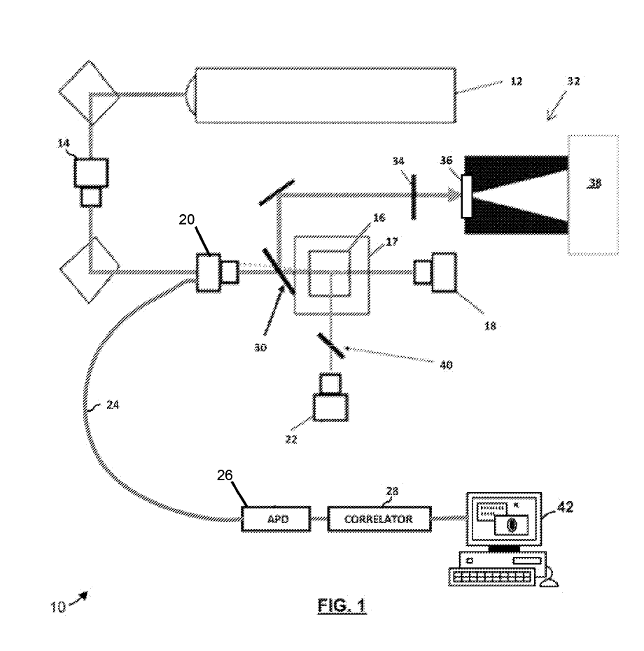

A DLS-Raman particle measurement system is presently contemplated as being an instrument of choice for implementing this invention. One such instrument is shown in FIG. 1 and is described in more detail in WO 2013/027034 A1, which is herein incorporated by reference. It will also be apparent to one of skill in the art that other types of instruments could also be used in connection with different aspects of the invention.

The particle measurement system 10 includes a coherent radiation source 12, such as a laser. The output of this laser is provided to an attenuator 14, optionally via one or more intervening reflectors, through a sample holder or cuvette 16 held in a cuvette slot 17, and on to a transmission monitor 18. Classical 90° optics 22 and/or backscatter optics 20 receive scattered radiation from a suspended particulate sample in the sample cuvette 16 and measure an intensity of light received from the light source 12 and elastically scattered by the sample in the sample cuvette 16. The received scattered radiation for one or both of these sets of optics can then be relayed via an optical fiber 24 to an Avalanche Photo Diode (APD) 26. The output of the photodiode 26 can then be correlated using a correlator 28 in the case of DLS, or integrated using an integrator in the case of SLS (not shown). A computer 42 is used to control the instrument and collect, analyze, and present measurements to the end user.

The system 10 also performs spectrometric detection by including a dielectric filter 30 in the backscatter path. This dielectric filter 30 relays longer wavelength light to a spectrometric detector 32, such as a Raman detector. The Raman detector 32 can include one or more laser notch filters 34, a diffraction grating 36, and a dimensional detector 38, such as a Charge Coupled Device (CCD). Although Raman detection is shown in FIG. 1 to take place in the backscatter path, it can also or alternatively take place from one or more of a number of different angles including from a pickoff point 40 in the classical 90° path. In one general aspect therefore, the spectrometric detector 32 may be configured to receive scattered light from the sample cell along a path orthogonal to the incident light and/or along a path reverse to the incident light for detection of backscattered light.

In operation, the laser 12 can be used for both DLS and Raman measurements, although separate lasers can also be used. During DLS measurements, the attenuator 14 is turned on so that the APD 26 is not saturated. During Raman measurements, the attenuator 14 is turned off to allow the high level of illumination used in Raman measurements. By alternating between DLS and Raman measurements, the system 10 can acquire information about both elastic and inelastic scattering. An alternative approach is to replace the dielectric filter 30 with a mirror and to configure the mirror to move in and out of the Raman optical path to alternately collect Raman and DLS data. One advantage of this approach is that it can work easily with existing DLS instrumentation.

The notch filter 34 or other detector-side filter in the system can also be configured to allow a small amount of the laser energy to pass through to the detector 32. The system 10 can then extract further information about the sample from this energy. For example, the system 10 could measure inelastic scattering of the Raman source wavelength. This contrasts with conventional approaches to Raman spectroscopy in which significant efforts are made to eliminate as much of the laser energy as possible after it has interacted with the sample. One of ordinary skill in the art would recognize that there are several ways to pass a small amount of laser energy, such as by adjusting the angle of incidence of the laser on the notch filter or removing one or more layers from the notch filter.

As will be described in more detail below, the instrument 10 is configured to investigate properties of proteins, including investigating low-frequency Raman spectral regions alone and in combination with other methods such as DLS or SLS. Instruments configured to perform these types of investigations have been able to reveal a significant amount of information about protein structure.

To derive information from the measurements, the system described above has been implemented in connection with special-purpose software programs running on general-purpose computer platforms in which stored program instructions are executed on a processor, but it could also be implemented in whole or in part using special-purpose hardware. Either way, the instrument can be configured to follow protocols that identify particular low-frequency features with one or more detection modalities. Low-frequency spectral regions and/or features can be identified and then compared, correlated, or otherwise associated with structural features or other characteristics of the sample under one or more conditions.

### The Intrinsic Structure and Properties of Proteins

Proteins are built from a polymerization of up to 20 different amino acids possessing common structural features, including an cc-carbon to which an amino group, a carboxyl group, and a variable side chain are bonded. The amino acids in a polypeptide chain are linked by peptide bonds that create the protein backbone, and this order defines the protein's primary sequence. Despite the commonality of these structural features, amino acids have a tremendous variation in their physical properties caused by variation in side chain properties, which can be polar, non-polar, acidic, basic, charged or neutral. The diverse properties of proteins are largely derived from this highly variable nature of the amino acid side chains.

The functionality of proteins is additionally driven by the three-dimensional structure into which the protein folds. These structural elements are described as protein secondary and tertiary structure, and are dependent on primary sequence and side chain properties, among other factors. Examples of secondary structural elements include α-helix, β-sheet and turns, and because secondary structure is a local phenomenon, i.e. driven by the interactions of various side chains, regions of different secondary structure (cc-helix and β-sheet) are most often both present in the same protein molecule. Proteins are often characterized by the percent of each of these structural elements present, or may be more loosely described as “mostly α-helical” or conversely “mostly β-sheer.” It is the basic organization of amino acids in proteins and their side chain variability that imparts their most interesting properties. For instance they are amphiphilic, possessing both hydrophilic and hydrophobic properties. The α-helix portion of a protein, for example contains one surface consisting of hydrophilic amino acids and the opposite surface consisting of hydrophobic amino acids, a perfect example of how primary sequence and side chain properties work together to define protein secondary structure.

The tertiary structure defines the final ‘shape’ of the molecule and maps the relationship of the secondary structures elements to one another. These secondary structural elements are stabilized by hydrogen bonds, salt bridges, disulfide bonds, or the formation of a hydrophobic core, and define the final form and functionality of the protein. Quaternary structure is formed when a number of protein molecules come together and function as a single unit.

Building on this, it becomes evident that both the amino acid sequence and higher order organization (secondary, tertiary, and quaternary structure) has a significant impact on solubility and functionality in aqueous and non-aqueous (as is the case for membrane proteins) environments.

Despite the clear definitions above and classification of proteins by their structural elements, proteins are not actually rigid molecules, but are metastable and dynamic. As such they can also assume a number of structural variants that are different from the preferred three-dimensional form. In some cases these structural changes enable or enhance functionality (cytochromes, enzymes) and in other cases will render it completely non-functional. The three dimensional structure into which a protein naturally folds is known as its native (functional) form, while heating or perturbing the local chemical environment can alter/destroy this structure, resulting in a ‘denatured’ state.

Proteins also exhibit a property known as amphoterism, in which they can act as acids or bases depending on conditions. Individual amino acids may be positive, negative, neutral, and polar, and it is the sum of all the individual amino acid contributions which are taken together that give a protein its overall charge. The isoelectric point (pI) of a protein is defined as the pH at which it carries no net electrical charge. The net charge on the molecule is modified by the pH of its surrounding environment and can become more positive or negative due to the loss or gain of protons (H+). At a pH below its pI, a protein will carry a net positive charge;

whereas at a pH above its pI, it will carry a net negative charge. As a result, proteins will have minimum solubility in water or salt solutions at a pH that corresponds to their pI and will often precipitate out of solution under these conditions. As a direct consequence of this, proteins can therefore be separated based upon their charge. Other modifications or degradations such as deamidation, glycosylation and oxidation can also lead to a change of the protein pI resulting in various charge isoforms, and a significant amount of charge heterogeneity even within a single protein.

One of the most studied aspects of proteins is its three-dimensional structure, as it is essential for correct functionality. In fact misfolded proteins (or denatured proteins) are not only non-functional but have also been associated with several diseases including amyloid diseases. Indeed the three-dimensional (native/folded) structure of a protein also gives rise to the ‘binding sites’ which drive its functionality and specificity. The highly variable region of the mAb is an example of a small folded region of the molecule that determines its activity as a therapeutic molecule. The primary sequence influences secondary and tertiary structure, but is not the only contributing factor. The study of the structure energetics and kinetics of the stability of the native state of the protein is another area of extensive study.

As stated previously the vast majority of protein therapeutics in the market place today are monoclonal antibodies (mAbs). While there is an enormous diversity of antibodies in nature their basic structures are very similar. The monomer is a ‘Y’ shaped molecule that consists of two identical heavy chains and two identical light chains connected by disulfide bonds. The variability, and therefore the molecular specificity, of an antibody is derived from a small highly variable region at the tip of the molecule allowing thousands of different functionalities to exist. Additionally antibodies are glycoproteins and contain covalently attached oligosaccharide chains (sugars). The sugars are attached to the protein in a process known as glycosylation which occurs after the initial synthesis of the protein in a process known as post-translation. There are a number of different post-translational processes which drive even further variability in protein structure and function.

From the foregoing therefore it should be clear that the almost infinite variability of proteins in terms of their primary, secondary and tertiary structure is what imparts their functionality, and high degree of specificity as putative therapeutic molecules. However, it can be further appreciated that it is this same complexity that can give rise to any number of potential ‘failure modes’ for these same proteins as stable, safe and efficacious products. As a result the pre-formulation and formulation hurdles that have to be overcome to determine the suitability of a candidate protein molecule as a drug product are significantly more complex and challenging than those of their small molecule counterparts.

### Proteins as Medicines

The overall stability of a large molecule is defined by a series of independent factors. Table 1 outlines some of the properties of a formulated protein drug product. While functionality and biological compatibility are key properties of the native molecule itself, changes in the formulation (pH, salt concentration etc.) can impact these properties. Further, factors such as long-term stability, shelf-life, and propensity to aggregate can be impacted by the formulation, as well as the presence of ‘hot spots’ on various parts of the molecule that may impact colloidal stability. The confluence of these behaviors will determine the manufacturability of any particular molecule.

TABLE 1

| | Factors Affected by Environment Protein May |
|---|---|
| Drug-Like Properties | Encounter |
| Function | Manufacturing: mechanical stress, temperature |
| Chemical stability | Mechanical stress, temperature |
| Colloidal stability | Storage and Shelf Life |
| Structural stability | Leachables |
| Biological compatibility | In vivo pH, ionic strength, protein-protein |
| | interactions |

As a result, biopharmaceutical candidates are subjected to a battery of physiochemical evaluations to determine optimal formulation conditions. Although the primary sequence is important to characterize drug molecules, changes in formulation primarily impact higher order structure, leaving the primary sequence unchanged. Therefore, characterizing modifications in tertiary and secondary structure is necessary to mitigate and/or determine as early as possible potential failure modes for these molecules, and to determine their suitability as commercial products.

In addition, target doses are on the order of milligrams of protein per kilogram patient body weight and limits on injectable volumes, although variable depending on whether the therapeutic is delivered intraveneously, intramuscular or subcutaneously, often set target formulation concentrations in excess of 100 mg/ml. This requires that molecules under development not only have the required efficacy, but also are highly soluble, with good long-term stability in both the finished product and the patient, and have formulated viscosity low enough to facilitate easy administration through small gauge needles.

The simple fact that the target molecule is produced from biological processes (i.e., fermentations or cell culture based upon e coli, Chinese Hamster Ovaries (CHO) cells, mammalian cells), versus a synthetic chemical process can add significant variability to the product. Factors such as the host cell used in the fermentation process or differences in growth media can affect product quality and manufacturing yields. Biotherapeutics such as monoclonal antibodies have molecular weights on the order of 300 times greater than traditional solid dosage forms and exhibit tremendous conformational flexibility and structural and chemical heterogeneity. These properties can be influenced by a number of physical and chemical environmental conditions present during product manufacturing, purification and product formulation. Additionally, yields from all parts of the development and manufacturing process are typically much lower than for their small molecule counterparts adding significant cost, uncertainty and complexity to their production and testing.

The emergence of generic versions of protein therapeutics and the inherent variability within both the biomanufacturing process and the lability of the molecules themselves has driven the industry to coin the term biosimilar, or follow-on biologic as opposed to the term generic. This is because neither the originator's clone or cell bank, nor to the exact fermentation and purification process is available. As a result, unlike small molecule pharma there will be some ‘differences’ in the two products. Requirements in place, particularly in Europe, aim to ensure that the safety and efficacy of the original manufacturer's product is preserved while at the same time recognizing that small variations are inevitable but are neither harmful nor impactful on the performance of the product. The measurement of bio similarity through a number of analytical and clinical means is therefore an important and emerging area. The implications of the foregoing are also driving new regulatory requirements, and both the USFDA and EMEA are looking for new and better analytical methods to support these developments. While the primary drivers are safety and efficacy which map directly to purity and potency, the concept of both have significantly different implications for protein-based products compared to their small molecule counterparts.

Therefore, the analytical requirements for developing, characterizing, testing and releasing protein therapeutics are complex and varied. Numerous new methods are beginning to emerge, and may be broadly divided into two discrete classes: methods that determine efficacy with respect to the target disease, techniques that measure macroscopic behavior such as the presence or extent of aggregation, unacceptably high formulation viscosities, poor solubility or low thermal stability and the forces that are driving these properties. The latter could reasonably be described as a quest for deriving new critical quality attributes (CQAs) or as a quality by design (QbD) approach.

A fundamental understanding of the molecular properties of the protein, as well as its behavior and interaction with the formulation, will help to understand the means by which undesirable effects can be minimized or eliminated. This might be achieved through a process of targeted amino acid modifications and/or the judicious selection of optimal formulation conditions. In many cases the appearance of these ‘effects’ are monitored through a screening program of stress testing or accelerated stability studies. These may involve concentration studies and the application of external stress such as heating, freezing or agitation. The choice of analytical technique used to monitor these effects is impacted not only by the value of the result obtained, but also by basic sampling requirements. In early formulation or formulation development, the amount of candidate molecule available to test can be extremely limited, and its production prohibitively expensive. Analytical methods that can work with small volumes under standard formulation conditions are therefore desirable. Automated, non-invasive (no reagent) and non-destructive tests are highly desirable at this stage in the product life cycle, so that the samples can be retrieved and tested again and/or reused on another analytical instrument.

These same needs drive the requirement to perform different and complimentary tests on the same sample at the same time, and hybrid/multi-modal instrumentation has begun to emerge as a result. For example, an approach that can measure high order structure of a protein along with aggregation could provide insight into both the molecular and physical state of the protein in solution. This combination of characterization could additionally provide mechanistic insight into the kinetics or thermodynamics of aggregation and/or denaturation. The industry generally considers that there is an analytical bottleneck for these types of determinations during the early stages of the therapeutic development lifecycle.

### The Analytical Challenge

Given the pace at which the analytical requirements in biotherapeutics is changing, analytical bottlenecks have emerged in the workflow, particularly in pre-formulation and formulation development (see Table 1). These bottlenecks, in turn, are driving the requirements for new analytical technologies and the ‘repurposing’ of existing technologies to accelerate product development, improve the understanding of the structure/function/efficacy relationship and identify features/issues as early as possible to avoid poor product attributes at later development stages.

The analytical and biophysical characterization challenges for a typical biotherapeutic are grossly different from those employed for small molecule discovery, development and manufacturing.

Understanding and characterizing the structure and function of proteins has been an area of significant academic interest for a long time, and as such there is a tremendous amount of basic research in this area. That said, as proteins have evolved into biotherapeutic ‘commercial products’ worth many billions of dollars, the required level of characterization and understanding needed to fully understand structure/function relationships and their impact on performance and safety of these products is much higher.

Measuring the Physicochemical Properties of Proteins and their Formulations

### Protein Aggregation and ‘Particulate Contamination’

While the primary drivers for both the industry and regulators are safety and efficacy which maps directly to purity and potency, the concept of both have significantly different implications for protein-based products. For example, the USP 788 sets specifications for foreign particulate matter contamination in injections and parenteral infusions. In the case of aqueous solutions of small molecule the definition of ‘foreign’ is relatively straightforward, whereas for protein-based parenterals the definition can become more complicated. Recently discussions around a new chapter, namely USP 787 has begun to define contamination as extrinsic, inherent and intrinsic. Extrinsic contamination is material present in the formulation which originates from outside of the manufacturing process, inherent describes contamination originating from within the process such as metal, silicone oil or plastic and intrinsic is contamination originating from the product itself such as protein aggregates, non-native proteins, host cell proteins or viruses. Clearly the latter (intrinsic) contamination question adds significant complexity to both the definition and means of characterization.

Intrinsic contamination is more generally regarded as the presence of aggregated protein product in a formulation and has become a major focus for both the industry and regulators alike. There are concerns with respect to safety and potential immunogenicity risk as well as worries of reduced efficacy of aggregated drug product. Additionally the appearance of aggregates during manufacture, packaging and/or storage of the drug leads to loss of product, and hence impacts manufacturing efficiency. Aggregated product may be induced by a variety of mechanisms including mechanical, thermal and/or chemical stress. Aggregates are generally characterized based upon their observed size; the industry and regulators have mostly settled on a definition of ‘sub-micron’ (100-1000 nm), ‘sub-visible’ (1-100 microns) and ‘visible’ (>100 microns) size ranges. ‘Aggregation’ may also refer to forms such as dimer, trimer and higher order oligomers, which are usually reversibly formed, and easily return to the monomeric state when the aggregate-inducing stress is removed. These traditional classifications are relatively crude and imprecise. To address this issue, recently Narhi et al have proposed the use of five classifications based upon size, reversibility/dissociability, conformation, chemical modification, and morphology. They also proposed the additional of the ‘nanometer’ size range to describe aggregates below 100 nm, which would previously have been described as oligomers or soluble aggregates.

While the size range described as sub-micron, or more recently nanometer, is clearly below the threshold of characterization by accepted optical imaging or light obscuration technologies, they are measurable by chromatographic or light scattering technologies. And while it is likely that these forms exist in most instances, their frequency and/or propensity to occur during product development may provide early indications of protein instability which could in turn lead to manufacturing and safety problems at a later stage.

One of the major hurdles in aggregate characterization is the lack of standards. The idea of synthetic reference materials that mimic protein aggregates in terms size distribution, density and refractive index is an active area of research but certainly not at the point where it has been adopted. This lack of standards has driven the need for additional analytical testing and the use of orthogonal means, i.e. the application of two analytical measurements based on different physical principles that attempt to extract the equivalent or similar property of a sample. Agreement or close agreement of two such methods provide increased confidence as to the value of either separately. Orthogonal methods for aggregate testing for example, might be flow microscopy and resonant mass measurement.

While aggregate and quantification is important, the ability to speciate a contaminant is a critical unmet analytical need in the industry. More recently technologies that can count, size and identify the chemical composition of a contaminant are very attractive, as they likely enable the contaminant source to be pinpointed.

### Viscosity

Therapeutic protein formulations are increasingly moving towards higher concentrations. This is driven both by the relative mass of the ‘functional’ part of the antibody compared to its total mass and also the focus on providing smaller volume injectables that a patient can self-administer as opposed to an expensive and time consuming intravenous (IV) based delivery mechanism, which has to be administered by a medical professional. Protein concentrations ranging from 50 mg/ml to 200 mg/ml are not uncommon now. However, the move towards these high concentration formations leads to considerable issues in both manufacturability and injectability, primarily due to the potential for high viscosity of these concentrated formulations (1-4). The generally accepted ‘rule of thumb’ is that the viscosity should not exceed 10 cP at the point of delivery and 20 cP for manufacturing/pumping. The presence of complex specific and non-specific interactions in these formulations can lead to self-association, irreversible aggregate formation, and other manifestations that negatively impact properties such as viscosity and thereby lead to issues in both manufacturing and delivery. While the dominant contribution to the viscosity will depend upon the volume fraction of these specific microstructures it will also depend upon the shear rate at which the viscosity is being probed. As a result, the importance of making even simple viscosity measurements at market target concentrations as early as possible in the development of a new therapeutic cannot be understated, and has pushed the requirement for viscosity measurement earlier in the overall development process. This necessitates the need for high throughput automated measurements on microliter quantities of material. However the challenges in the area are not yet fully appreciated from the perspective of understanding the critical criteria required to optimize performance and this is likely to drive even further developments in the development and use of more complex rheological technologies.

Understanding the Physicochemical Properties of Proteins and their Formulations

Identification and characterization of aggregates, although important, is only part of “solving” the puzzle. Equally important is to develop an understanding of the underlying drivers and mechanism of protein aggregation, as this knowledge can actually mitigate their formation. Technologies that can therefore measure and track the presence, kinetics and thermodynamics between oligomeric forms as a function of formulation conditions can provide significant insight into the driving forces governing overall stability and perhaps shelf-life of a product in development.

More recently the role of native protein-protein interactions has garnered significant interest. Electrostatic interactions are implicated, and even relatively subtle conformational changes may drive interaction energetics that are favorable to aggregation. The impact these weak, non-specific interactions has on the stability of a biotherapeutic has driven significant interest in their characterization as predictors of formulation stability. For example the second virial coefficient (B22), which can be derived from light scattering measurements, has been used to predict propensity for aggregation. Proteins, unlike many simple colloidal systems, have heterogeneous surface charge distribution. This asymmetry in the local charge distribution can lead to dipole formation and thereby enhance the propensity for self-association and increased viscosity. Technologies that can measure these interactions and track changes in protein charge and/or protein conformational states as a function of stress or formulation parameters can provide an understanding of the optimal design space for the end product.

Raman spectroscopy is a vibrational molecular spectroscopic technique that provides the ability to extract a wealth of chemical, structural, and physical parameters about a wide range of materials including proteins and biotherapeutic proteins under formulation conditions. Raman spectroscopy simultaneously derives protein secondary structure (Amide I and III) and tertiary structure markers (aromatic side chains, disulfide bond, hydrogen bonding, local hydrophobicity). These higher order structural determinations can be performed at actual formulation concentrations, 50 mg/mL or greater for mAbs, rather than at the diluted concentrations required by conventional methods, i.e. less than a few mg/mL for circular dichroism (CD). As a result, protein secondary and tertiary structure, perturbation/unfolding, melting temperature, onset temperature of aggregation, and enthalpy and free energy values can all be derived leading to improved understanding of competing pathways of unfolding/structure change and aggregation, and ultimately, unique insights into the mechanism(s) of aggregation to help improve formulation stability. While there has been a large body of research with respect to its utility for studying proteins its utility for characterizing biotherapeutics has been limited and overshadowed by other approaches such as circular dichroism and Fourier transform infrared spectroscopy (FTIR). Recent advances in Raman instrumentation, have however helped stimulate a renewed interest in its use for characterizing biotherapeutics (see published PCT application number PCT/GB2012/052019, which is herein incorporated by reference). However, a quick survey of the scientific literature reveals that most of the work has focused on the more well understood part of the spectrum known as the ‘fingerprint’ region i.e. 400-1800 cm⁻¹. Within this range classic functional group vibrations exist such as carbonyl stretching vibrations (Amide I), disulfide (S-S) stretching vibrations and host of other modes describing the complement of amino acids and their 3D arrangement. The spectral region, however, below 400 cm⁻¹ has been much less well studied.

Given the low frequency nature of these vibrations they may be assigned to ‘whole protein’ motions and therefore may be assumed to more closely reflect the functionality of the protein and its behavior and interactions with itself and its environment. In particular, changes in amplitude and frequency of these modes may reflect changes in the overall protein charge, protein dipole, protein-protein interactions (specific and non-specific) or its interaction (binding) with other proteins or target molecules. In addition, spectral changes may also reflect the protein's interaction with the solvent, the pH of that solvent and other ions in solution and may provide indications of the stability (kinetic and thermodynamic) of the protein in a particular solution or formulation. They may further reflect the development of protein networks, aggregation, folding and unfolding as well changes as a result of protein crowding at high concentration. The fact that some low-frequency water vibrational modes associated with hydrogen-bonding between water molecules or those water molecules with the protein (inter and intramolecular) may also occur in the same spectral region, this low-frequency spectral interval may provide a wealth of information useful in the development and study of the efficacy and stability of biotherapeutics. These modes may also provide insight into or the actual measurement of protein viscosity, stability, functionality or the PI of the protein by varying concentration, pH, temperature, time, ionic strength and other formulation conditions. Additionally protein modifications via pegylation or glycosylation are also expected to result in changes in this same spectral region making the technique additionally valuable in the study of post-translational modifications or more sophisticated methods for the delivery and controlled release or half-life of the protein in a patient.

Through further study it is reasonable to assume that the nature of the Raman peaks occurring in this spectral region for biotherapeutics such as monoclonal antibodies already in the market or in development will be improved, the current lack of understanding should not overly hamper the utility of the above analytical method since we may utilize calibration or other spectral or multivariate techniques to correlate the observed spectral changes to existing primary methods of measuring, for instance, protein charge, viscosity or the use of other more complex spectroscopic tools such as THz spectroscopy or small angle neutron scattering. These may be accomplished using a variety of well understood model proteins and ‘transferred’ to actual molecules of industrial and medical interest. Normally Raman spectroscopy is employed using laser excitation in combination with a spectrograph to disperse the Raman scattered light which is then incident on either a 1D or 2D array detector such as a CCD. In other implementations a Fourier transform instrument may be employed in a technique known as FT-Raman. In almost all instances the instrumentation collects the entire spectral region with emphasis on the fingerprint region or the higher frequency hydrogen stretching modes (SH, CH, OH, NH) between approximately 2800-3600 cm⁻¹. The resolution of a typical Raman spectrograph is typically quite high (2-8 cm⁻¹) enabling the distinction between the relatively sharp and closely spaced multitude of Raman peaks typically observed for a large and complex molecule such as a protein. However, given the relatively narrow spectral range (400 cm⁻¹) we employ in this approach, and the fact that the peaks in this low-frequency range tend to be intense and broader, lower-cost and lower-resolution spectrographs and instrumentation may be employed. In fact it is possible to even employ a simple filter-based instrument that is tuned to one or more of these low frequency vibrations that have been previously determined to be sensitive to the particular protein characteristic of interest, e.g. charge, binding, viscosity or others. An instrument could be as simple as a laser, a sample cell, a laser notch filter and one or more Raman line filters. These Raman line filters can have bandwidths of about 10, 25, or even 50 cm⁻¹. Conversely, a high-resolution spectrometer can be built with its range confined to a reduced bandwidth to improve its characteristics within the low-frequency spectral range. The output of the instrument can be highly specific to a particular property, or it may include logic that simplifies, aggregates, or otherwise processes the spectral information to produce a processed result, such as a quality control measure, or a measure of biosimilarity or bioequivalence.

While this patent application focuses on the use of Raman spectroscopy, other vibrational spectroscopic methods, particularly with respect to the measurement of the effects of protein solvent/protein water interactions, may be substituted. These include infrared (FTIR) and near-infrared, far-infrared and terahertz spectroscopy. Additionally, comparisons and correlations with other techniques such as rheology, chromatography or light scattering may provide further insights and instrumentation that integrate or combine low frequency Raman shift measurements with these techniques will provide additional value.

### EXAMPLES

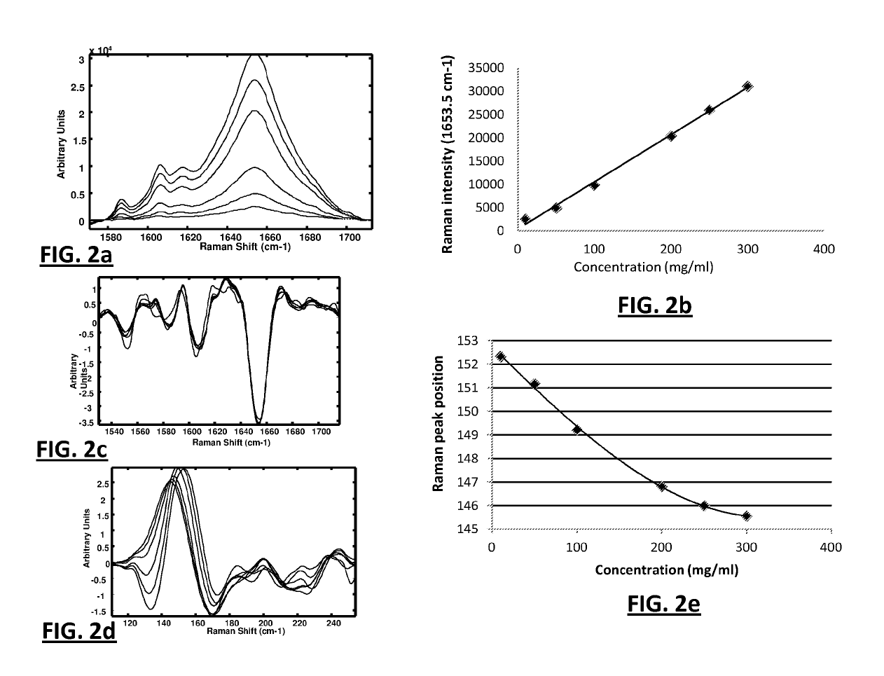

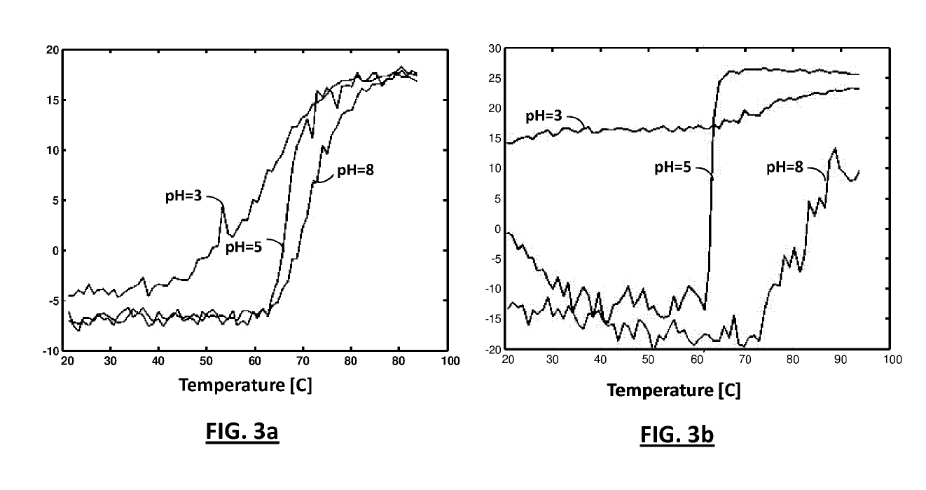

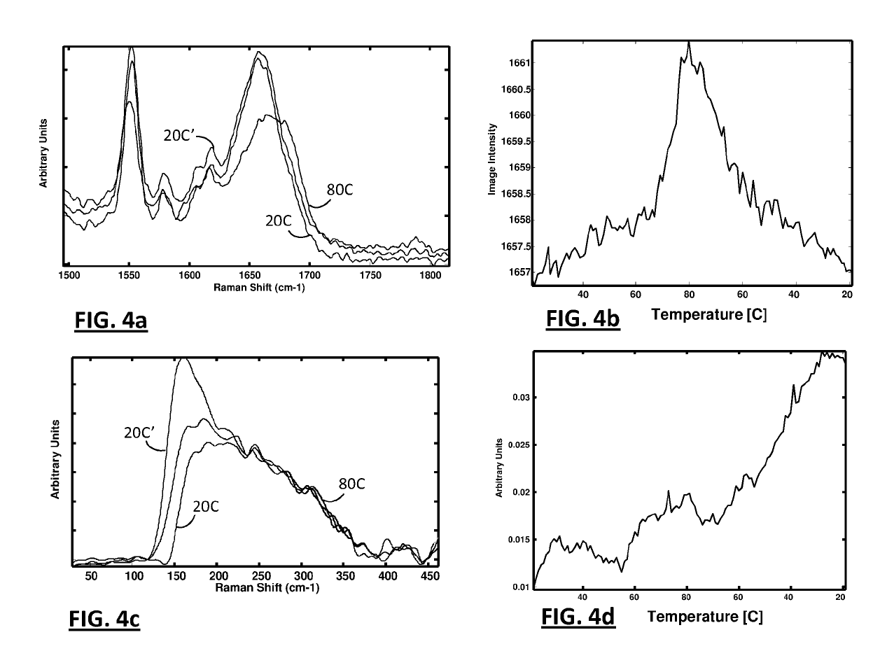

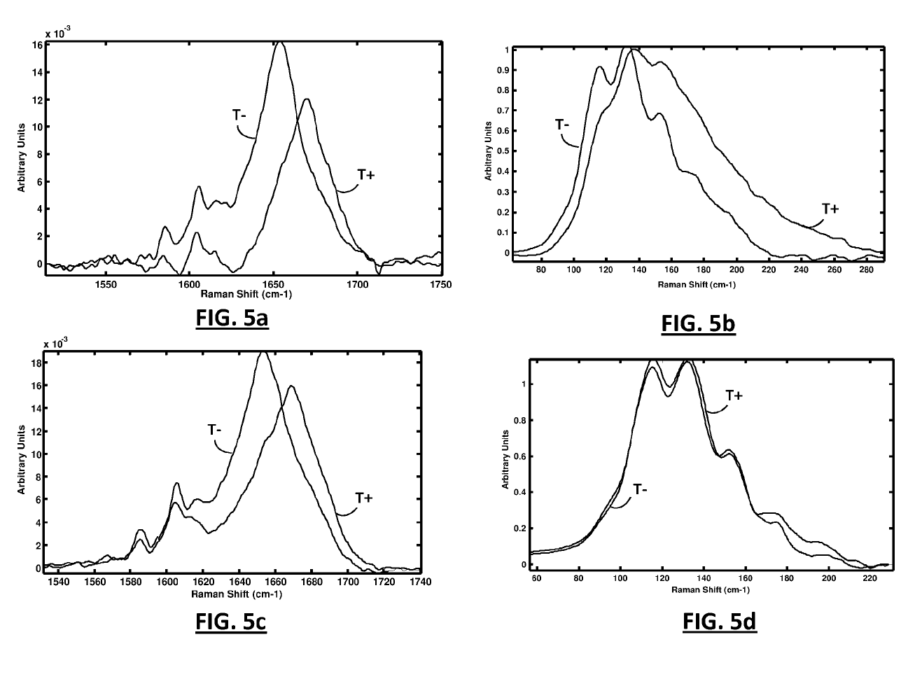

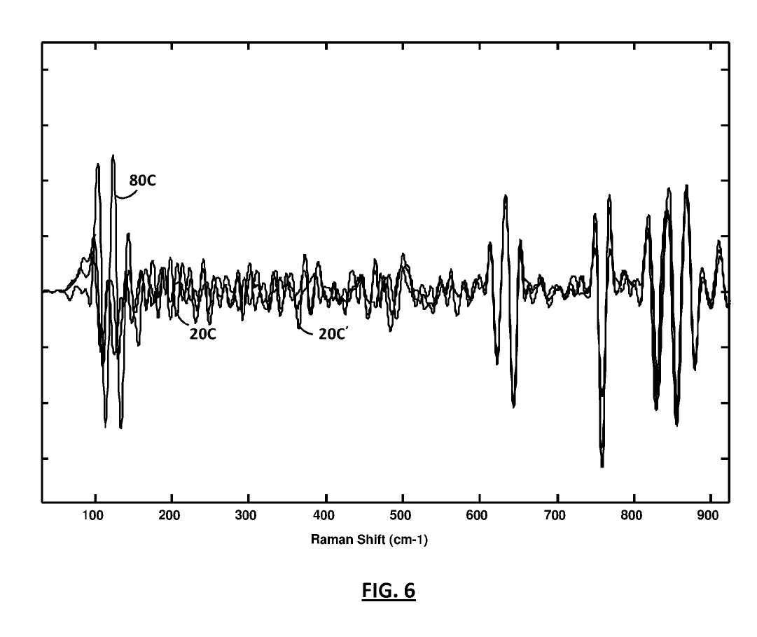

A number of experiments were carried out using the system of FIG. 1 on samples of bovine serum albumen (BSA) in phosphate buffered saline (PBS). The results are plotted in FIGS. 2-5. FIG. 2a is a plot of Raman spectra of a sample of BSA in PBS in the Amide I region as a function of concentration. FIG. 2b is plot of concentration versus intensity of peak at about 1650 cm⁻¹. FIG. 2c is a plot of normalized second derivative spectra of the amide I region at six concentrations. It shows no change in the peak position at ˜1650 and therefore no change in the protein secondary structure with concentration. FIG. 2d is a plot of the second derivative of the low frequency 100-250 cm⁻¹ portion of the spectrum as a function of concentration. It shows significantly different spectra due to changes in protein intermolecular interactions and interaction with the solvent. FIG. 2e is a plot of peak position as a function of concentration, with data from the second derivative spectra in FIG. 2d.

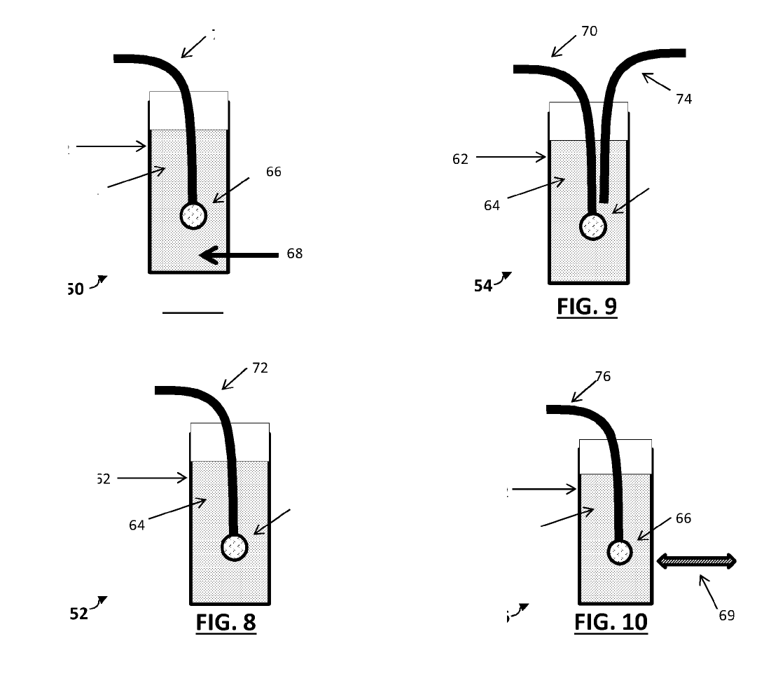

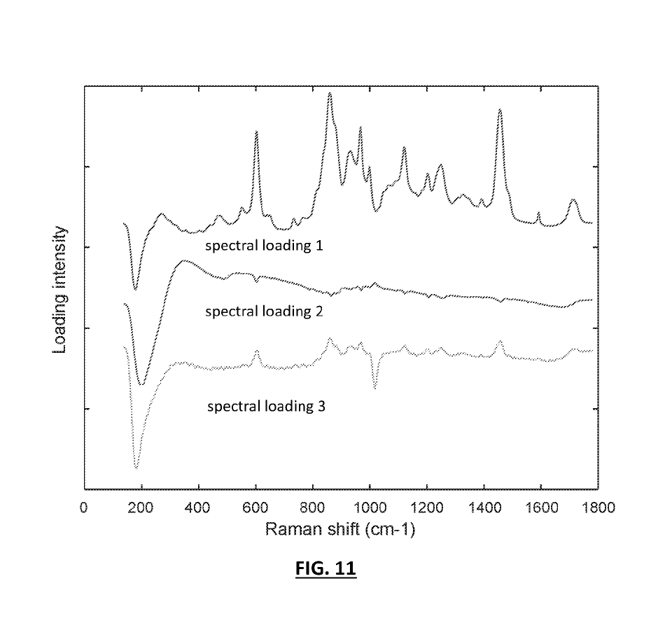

FIG. 3a is a plot of principal component scores as a function of temperature derived from the Amide I region of the Raman spectra of BSA at 3 different pH conditions (pH3, pH5 and pH8) between 1600 and 1800 cm⁻¹. The plots indicate the differences in the Tm and cooperativity of the protein unfolding due to the differences in pH. FIG. 3b shows the scores of a principal component analysis of the low frequency (100-300 cm⁻¹) Raman spectra of BSA at 3 different pH conditions plotted against temperature. Unlike the Amide I traces these figures show a markedly different behavior for the pH 5 trace which is close to the isoelectric point (pI) of the protein and is indicative of a more pronounced intermolecular association (aggregation) of the protein under these conditions.

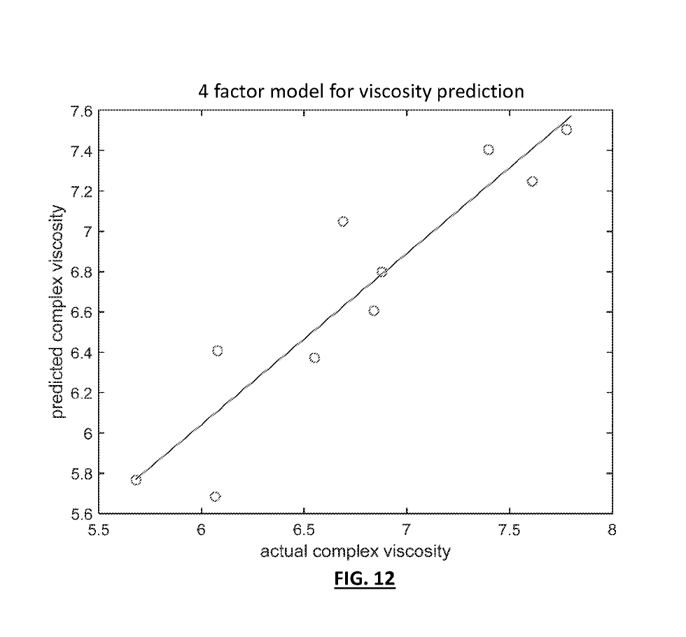

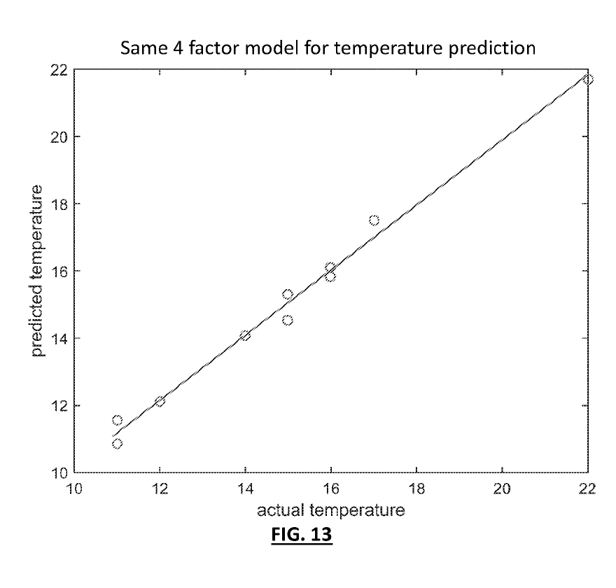

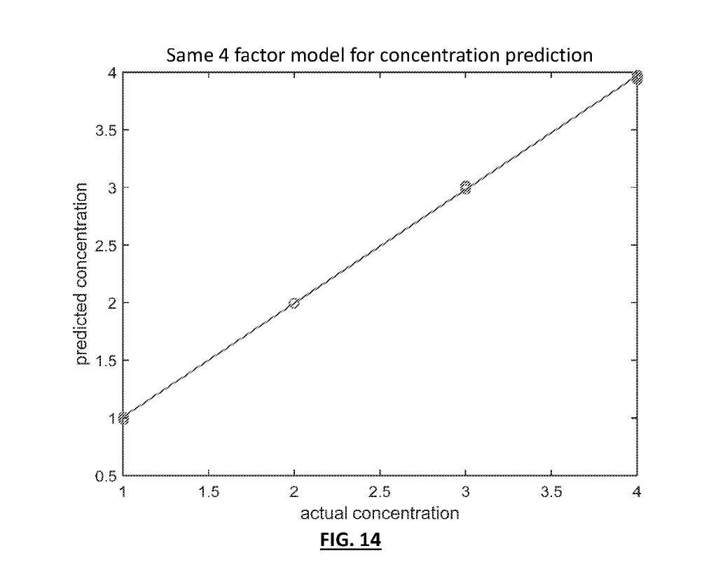

FIG. 4a is a plot of spectra of lysozyme solutions in the Amide I region at 20° C., 80° C. and again at 20° C. (identified in the plot as 20C). The sample is ramped from 20° C. to 80° C. and then cooled back down to 20° C. The data shows the reversible unfolding of the protein at elevated temperature and its complete refolding when the temperature is returned to 20° C. FIG. 4b is a plot of peak position of the Amide I plotted as a function of the up and down ramp. It can be seen that the Amide I position is almost completely reversible starting at approx 1657 cm⁻¹ and climbing to approx 1661. It returns to approx 1657 and an equivalent secondary structure on re-cooling. FIG. 4c is a plot of spectra of the same lysozyme sample in the low frequency region upon heating and cooling at 20° C., 80° C. and then again at 20° C. In this case the data is not reversible and indicates a permanent change to the intermolecular structure. FIG. 4d is a plot showing the temperature dependence of the spectra in FIG. 4c at 152 cm⁻¹.

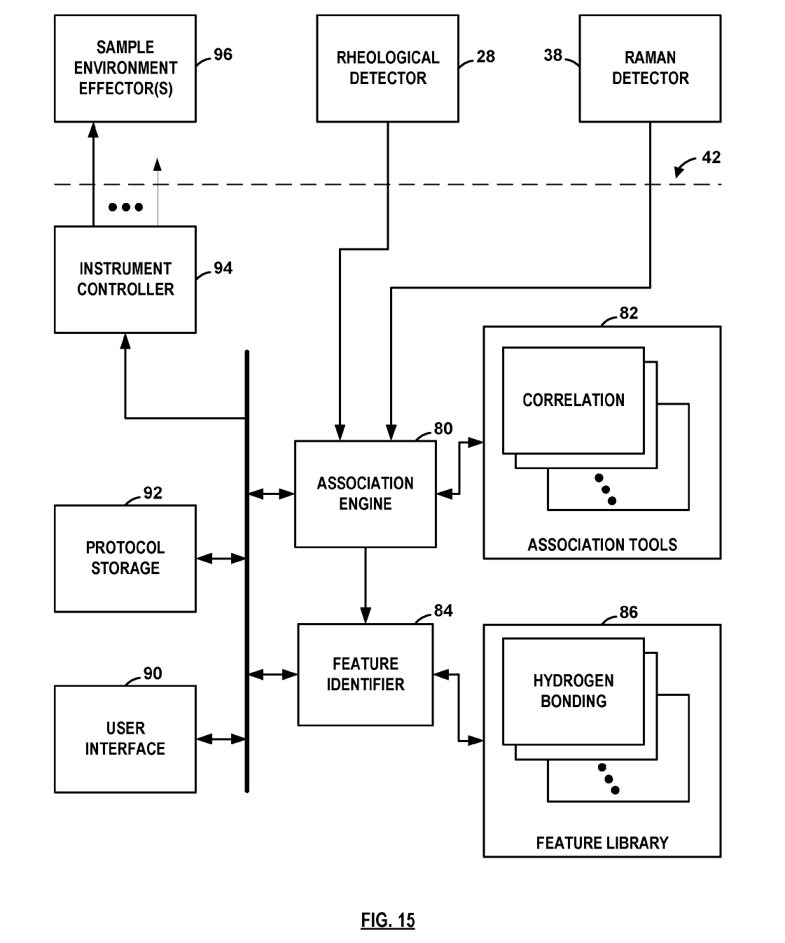

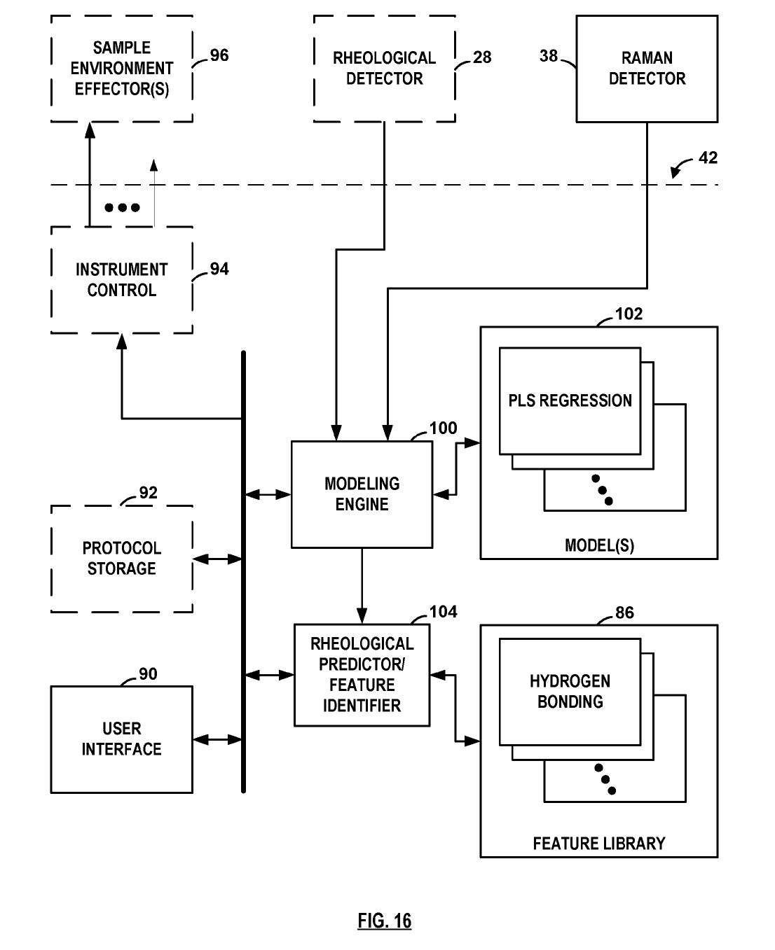

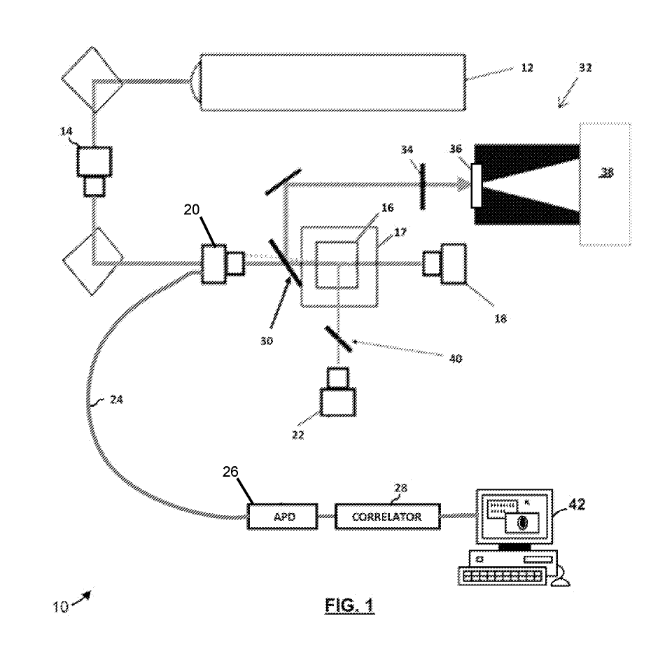

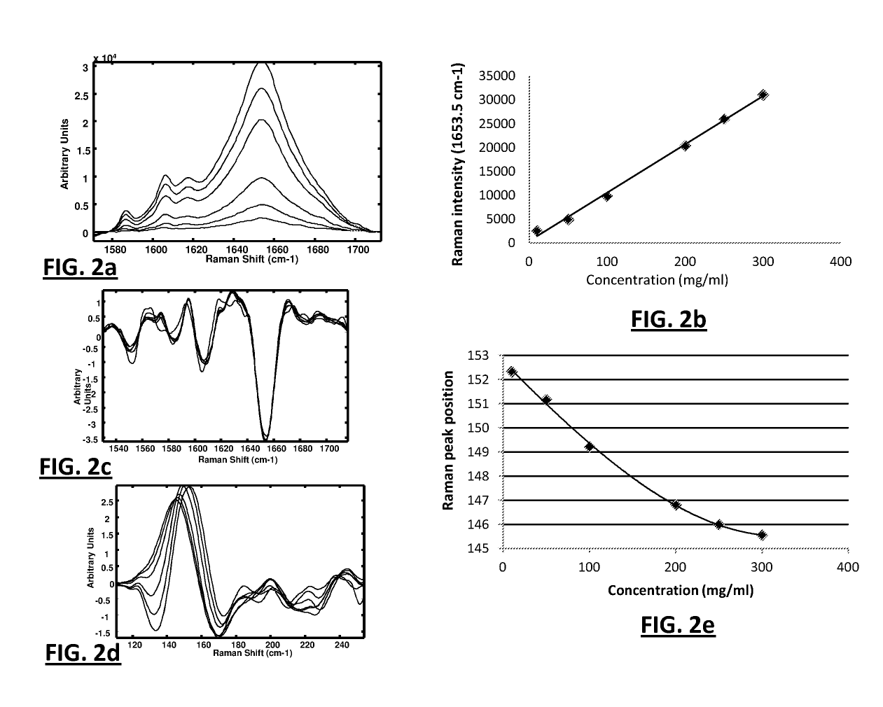

FIG. 5a is a plot of the spectra of human serum albumin (HSA) below (T−) and above (T+) unfolding temperature Tm in the Amide I region. The spectra show the classic unfolding of the protein as measured by the shift in the Amide I frequency. FIG. 5b is a plot of low frequency spectra of the same sample below (T−) and above (T+) unfolding temperature Tm. FIG. 5c is a plot of spectra of HSA treated with H₂O₂ (oxidizer), showing below (T−) and above (T+) Tm as in FIG. 5a. It shows the classic protein unfolding with temperature and very little difference with respect to the spectra obtained without treatment with H₂O₂. FIG. 5d is a plot of low frequency spectra of the H₂O₂ treated sample. It shows markedly different behavior and again indicating a different intermolecular structure than that observed for the untreated sample and one that is ‘stable’ at both low and high temperatures.

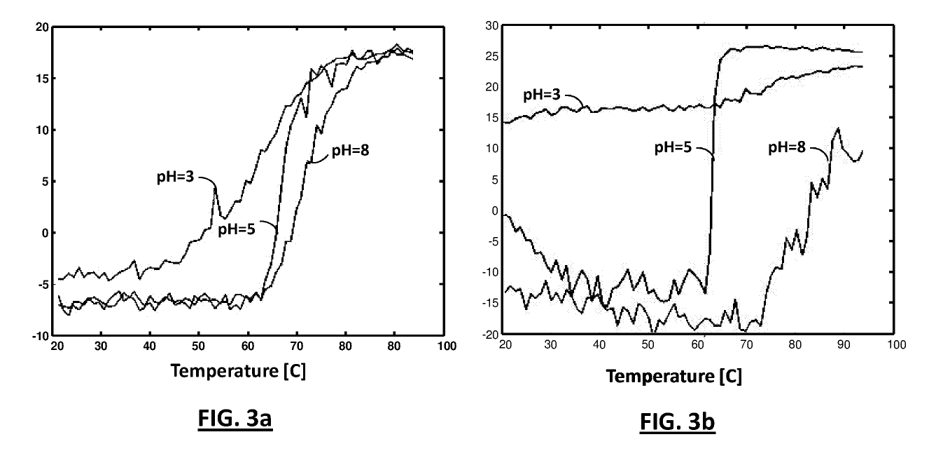

FIG. 6 is a plot of second derivative Raman spectra of a solution of a monoclonal antibody at low (20° C. T−) and high (80° C. T+) temperature. Data in the range approximately 100-200 cm⁻¹ show marked changes on heating while data in other parts of the spectrum, notably 800-900 cm⁻¹ (tertiary structure), show only minor changes. Other secondary structural markers in other parts of the Raman spectra (not shown) show equally small or non-existent changes with temperature. In this case the low frequency region therefore provides a more sensitive measure of antibody structural perturbation or interactions with itself or the buffered solvent.

Referring again to FIG. 1, the particle measurement system 10 can use marker particles of known size to perform microrheology measurements. In some embodiments these can be simply introduced into the cuvette 16. This helps to provide high quality microrheological (e.g., DLS) measurements and, when combined with spectrometric (e.g., low frequency Raman) measurements, can provide deeper insights into the sample.

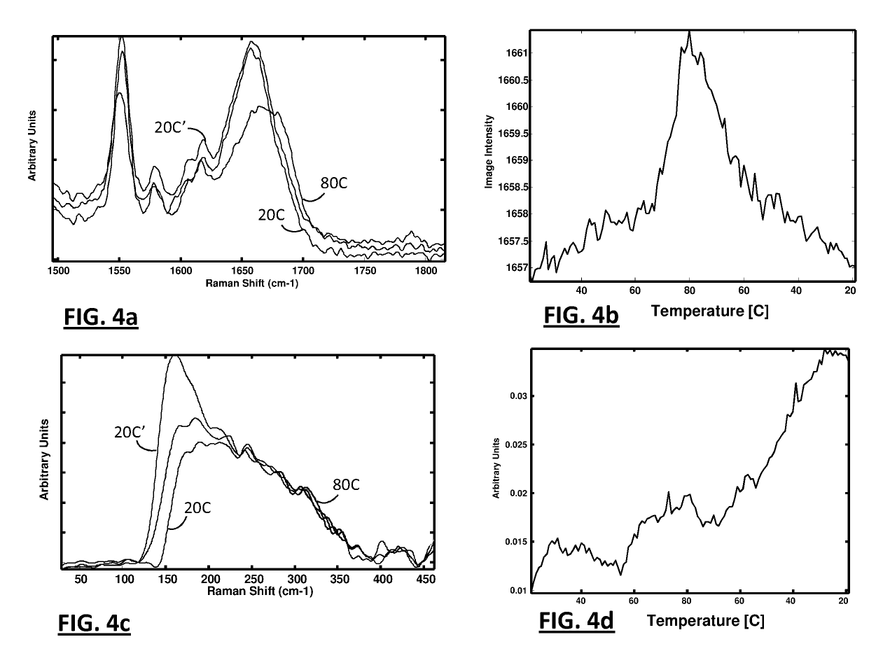

Referring also to FIG. 7, the particle measurement system 10 can also use a specialized probe comprising an optical fiber 70 connected to a fluid permeable cage 66 within which marker particles are trapped. The probe can then be immersed into a sample 64 held in a cuvette 62 in the instrument. The microrheological measurements can then be performed inside the cage 66, with the illumination and collected signals being conveyed through the fiber 70 that terminates inside the cage 66. This embodiment has the advantage that fewer particles need to be introduced into the sample and the particles can be easily removed from the sample, allowing it to be readily recovered. Spectrometric excitation and collection measurements are performed through an optical path 68 that intersects with part of the cuvette 62 that is outside of the cage 66.

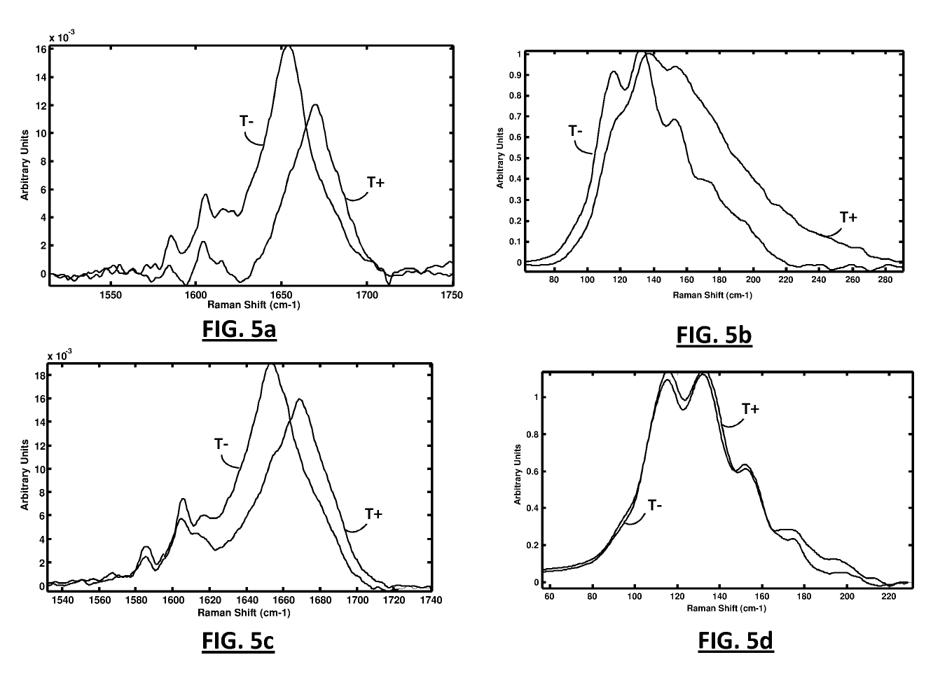

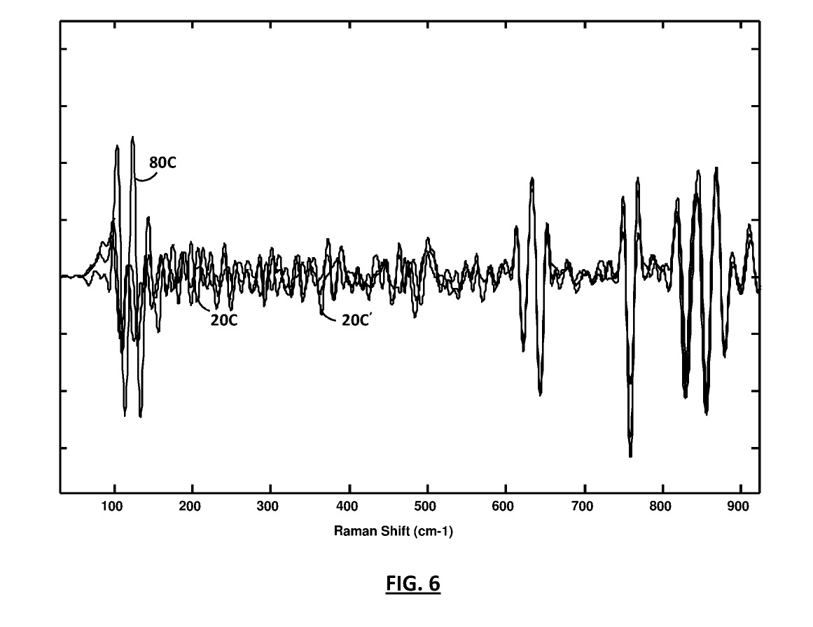

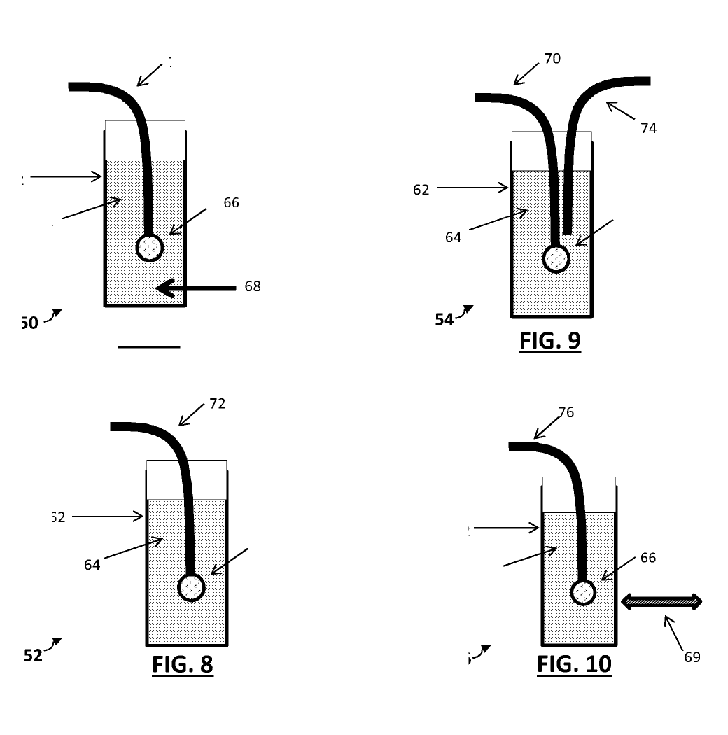

Referring also to FIG. 8, an alternate probe can perform both the microrheological and spectrometric measurements entirely through a single optical fiber 72 that terminates inside the cage 66. And as shown in FIG. 9, the spectrometric and microrheological measurements can each be performed with their own fibers 70, 74. FIG. 10 shows a further probe comprising an optical fiber 76 and cage 66 that operates like the embodiment of FIG. 7, except that spectrometric measurements are performed through an optical path 69 that intersects with or is proximate to the portion of the sample volume that is held inside the cage.

Other configurations of probe-based systems could also be built. While the cage 66 is shown in FIGS. 7-10 defining a spherical volume, for example, it could also define other closed shapes, such as a cube or cuboidal shape. A variety of other fluid-permeable membrane configurations could also be used to keep the particles from contaminating the sample, such as one in which a membrane forms a partition between two parts of a cuvette.

The cage 66 can be made of any suitable material, such as stainless steel or glass. It can be made permeable to the sample but not to the particles through any appropriate microstructure, such as a mesh or holes, such as laser-cut holes. In one embodiment, the probe particles are on the order of 1 μm in diameter.

### Validation and Modeling

A data set that comprises 116 Raman spectra was acquired from a methacrylate diblock copolymer sample for different values of concentration (1-4 mg/ml) and temperature (24-10-24 degrees). For each of the measurements the viscosity was measured by the system of FIG. 1 using the probe particle approach, and complex viscosity was established for each of the 116 data points. The result is a pair of data matrices with one matrix having dimensions of 116 samples by the number of points in the Raman spectrum, and another being 116 by 3. (column 1: concentration, column 2: temperature and column 3: viscosity).

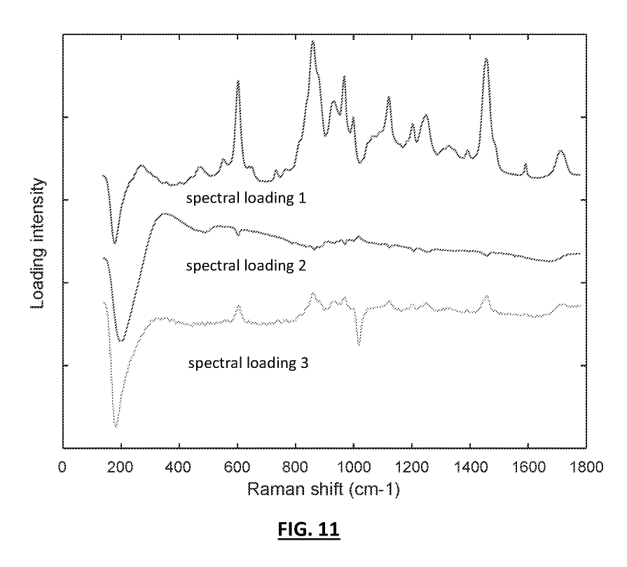

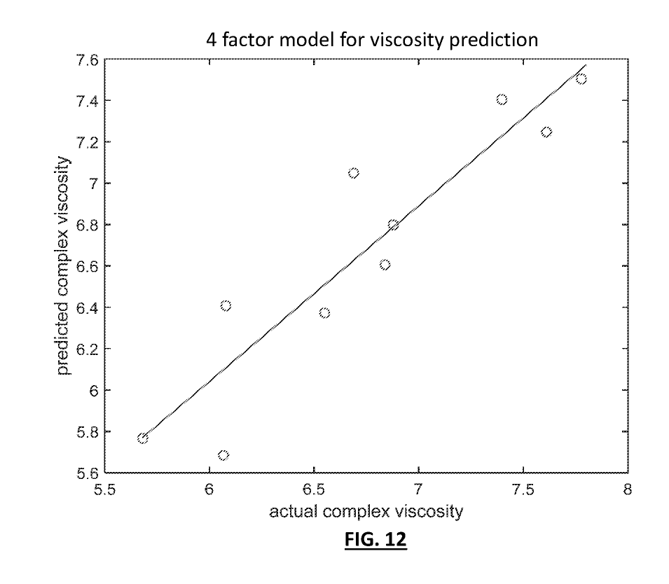

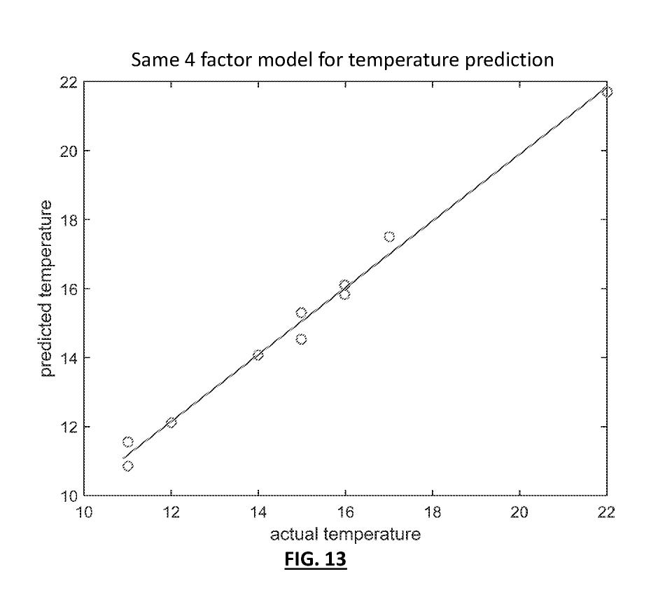

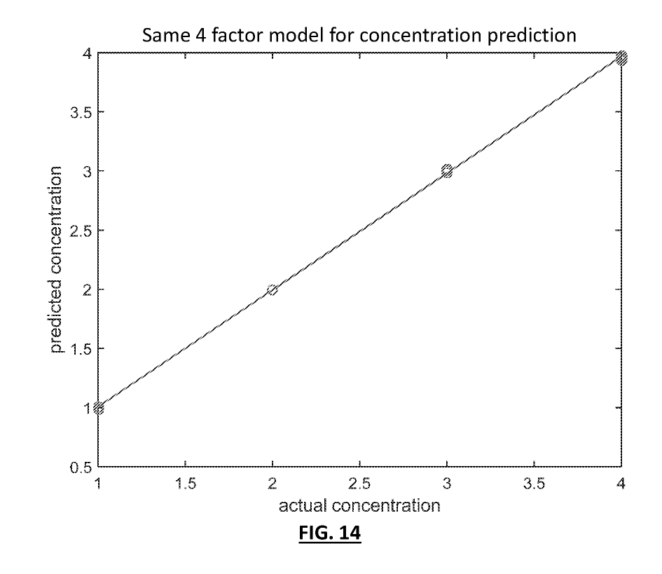

A Partial Least Squares (PLS) regression model was then developed for these data matrices. The data was first randomly split into a larger training set and a smaller prediction set. This allowed values in spectra that the model has never seen to be predicted. Referring to FIG. 11-14, the calculation produces scores and loadings and regression coefficients that can then be used on the prediction set. The graphs are the ‘predicted’ values for all 3 variables and the straight lines in FIGS. 12-14 are simple least squares fits of the actual versus predicted output. It should be noted that the peaks in the first loading are from the polymer and therefore have a strong dependence on concentration. The other loadings have most ‘information’ in the lower wavenumber range (approximately 100-300 cm⁻¹), and this is what is believed to be correlated with the change in viscosity. This confirms that the low frequency region is an interesting region to ‘observe’ these sample properties.

This modeling approach can simplify later measurements. Once a good model is developed from Raman and rheological data, viscosity can be predicted from a Raman measurement alone. This may be useful in situations where many measurements need to be taken, such as in manufacturing, counterfeit detection, and quality control. In these situations, the model may be stored in and used by an instrument's computer on an ongoing basis, or the model might be confirmed or adjusted during a calibration phase.

While a PLS model was used in connection with these measurements, other multivariate analysis techniques could also be employed. And while the complex viscosity data was derived from the probe particle approach, this type of rheometric data could also be obtained from other sources, such as a rotary rheometer.

### Illustrative Implementations

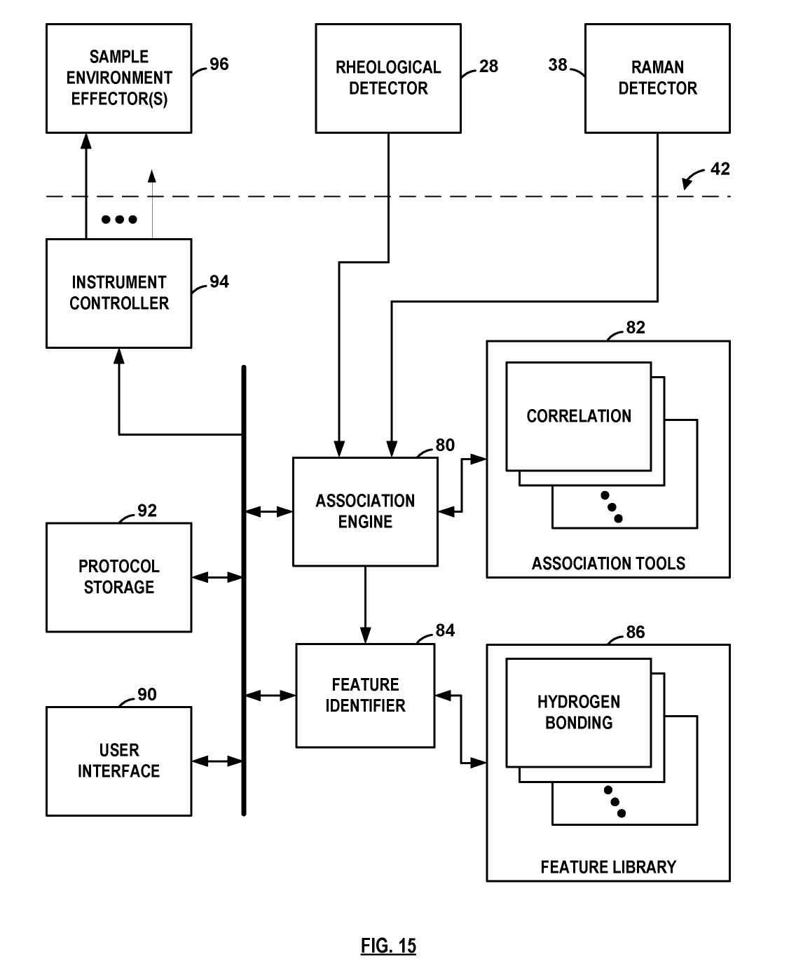

An implementation of the system of FIG. 1 can be broken down into a plurality of units, such as the analytical, control, and reference blocks shown in FIG. 15. In this implementation, an association engine 80 receives detection signals from the Raman detector 38 and the rheological detector (a correlator in the case of DLS measurements) 28, or another rheological measurement source. Other rheological measurement sources may include viscosity measurement by capillary flow, as for example described in US 2013/0186184 and implemented in the Malvern Instruments Viscosizer 200. Raman measurements may be taken on a liquid sample within a capillary, enabling the simultaneous measurement of viscosity with acquisition of Raman spectra of the sample.

The association engine 80 then uses one or more stored association tools 82 to determine how rheological values are associated with spectral features. The association engine 80 can use a correlation tool, for example, to determine what wavelengths are most strongly correlated with changes in viscosity.

A feature identifier 84 can then identify, or at least attempt to identify, a structural feature or other characteristic of the sample from the results of the association. The identifier can perform this identification using a feature library 86 of identification profiles for different candidate characteristics. Changes to spectral characteristics associated with hydrogen bonding, for example, may indicate that it is a source of variations in Raman measurements. In some cases, the feature identifier 84 may only make one or more identification suggestions that serve as a starting point for further investigation.

The system can also include protocol storage 92 that allows a user to design and/or select one of a series of measurement protocols through the instrument's user interface 90. The protocols can include stored directives to an instrument controller 94, which can drive one or more sample environment effectors 96, controls acquisition of measurements, and oversees other system functions, such as turning the radiation source 12 (FIG. 1) on and off. The controller 94 can drive water bath thermostat settings and an automated pipette, for example, to acquire a series of measurements over a range of temperatures and pH. Resulting measurement data, association results, and/or identification results can then be stored, presented to the user on the instrument's user interface 90, or used in other ways.

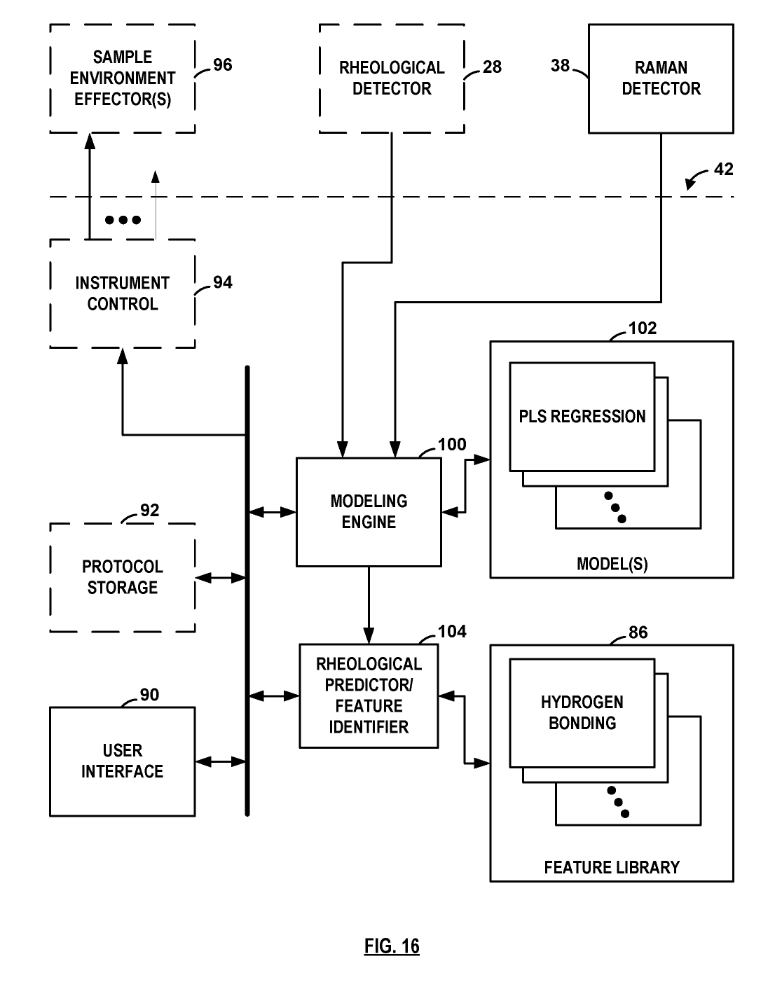

Referring to FIG. 16, a variant of the system of FIG. 1 can employ a multivariate model, such as a PLS regression model, as discussed above. This functionality can be provided in addition to some or all of the features of FIG. 15. In this type of embodiment, a modeling engine 100 receives detection signals from the

Raman detector 38 and the rheological detector (correlator) 28, or other rheological source. It then uses one or more stored modeling tools to build one or more models 102 of the sample. It can use a PLS regression model, for example, as discussed above.

The system can then interrogate the model using one or more parts of a rheological predictor/feature identifier 104. This can allow the system to predict rheological values, such as viscosity, from Raman spectra, without needing to perform rheological measurements. The rheological predictor/feature identifier can also be used to identify a structural feature or other characteristic of the sample from the model, such as from the loadings in a PLS regression model. Multivariate analysis techniques are described, for example, in Chemometrics, by Muhammad A. Sharaf et al., Wiley-Interscience (1986) and Detection and Identification of Bacteria in a Juice Matrix with Fourier Transform-Near Infrared Spectroscopy and Multivariiate Analysis, Journal of food protection, 12/2004; 67(11):2555-9, which are herein incorporated by reference.

The various blocks shown in FIGS. 15 and 16 are preferably implemented as software running on the computer 42, although, as discussed above, they could also be implemented in whole or in part using special-purpose hardware. And while functions of the system can be broken into the series of blocks shown in FIGS. 15 and 16, one of ordinary skill in the art would recognize that it is also possible to combine them and/or split them to achieve a different breakdown. In some cases, it may be desirable to run different parts of the system on different computers.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

1-61. (canceled)

62. An apparatus for spectroscopic sample structure investigation for a sample that includes a dispersed chemical species in a liquid phase, the apparatus comprising:
a sample holder for holding the sample;
a laser source for illuminating the sample held by the sample holder;
a particle motion detector positioned to detect motion of a plurality of marker particles in the sample held by the sample holder; and
a spectral detector positioned to receive a spectrum from the sample resulting from illumination by the laser source.

63. The apparatus of claim 62 further comprising means for extracting at least one characteristic of the dispersed chemical species in the sample from both the spectral detector and the particle motion detector.

64. The apparatus of claim 63 wherein:
the spectral detector is configured to receive Raman scattered light from the sample so that the spectrum is a Raman spectrum; or
wherein the spectrum is an infrared, near-infrared, far-infrared or a terahertz spectrum.

65. The apparatus of claim 62 wherein:
the spectral detector is configured to receive Raman scattered light from the sample so that the spectrum is a Raman spectrum; or
wherein the spectrum is an infrared, near-infrared, far-infrared or a terahertz spectrum.

66. The apparatus of claim 62 further including a stored machine-readable model that associates spectra of dispersed chemical species with at least one rheological property of the dispersed chemical species, and prediction logic responsive to the stored machine-readable model and to an output of the spectral detector to derive at least one predicted rheological property value for the sample in the sample holder

67. The apparatus of claim 66 wherein the machine-readable model is a multivariate model.

68. The apparatus of claim 62 further including at least one of: i) rheological information extraction logic responsive to the particle motion detector, and spectral information extraction logic responsive to the spectral detector; ii) information extraction logic responsive both to the particle motion detector and to the spectral detector; and iii) protein characteristics extraction logic responsive both to the particle motion detector and to the spectral detector.

69. The apparatus of claim 62 wherein the particle motion detector includes an optical fiber coupled to an optical detector.

70. The apparatus of claim 62 wherein the sample holder includes an unmarked sample volume and a marked sample volume separated by a partition that is permeable to the sample but not the particle marker particles

71. The apparatus of claim 62 wherein the partition optionally defines the marked sample volume as a closed volume.

72. The apparatus of claim 62 wherein the spectral detector is operative to detect frequencies within a spectral feature range of between about 0 and 400 cm⁻¹.

73. The apparatus of claim 62 further including spectral identification logic operative to detect spectral features associated with predetermined characteristics of the sample.

74. The apparatus of claim 73 further including logic for determining:
a measure of stability of the dispersed chemical species responsive to the spectral detector;
a measure of protein stability responsive to the spectral detector; and/or
a quality control measure responsive to the spectral detector.

75. The apparatus of claim 73 further including a single spectral feature band-pass filter located in an optical path between the sample and the spectral detector, and wherein the spectral detector is operative to measure an amount of energy in the pass band of the filter that includes information about one of the predetermined characteristics.

76. The apparatus of any of claims 73 further including a plurality of spectral feature band-pass filters each located in an optical path between the sample and the spectral detector, and wherein the spectral detector is operative to measure an amount of energy in each of the pass bands of the filters that includes information about one of the predetermined characteristics.

77. The apparatus of claim wherein the spectral identification logic is operative to
detect at least one spectral feature associated with solvent-solute interactions;
detect at least one spectral feature associated with solute-solute interactions; and/or
identify at least one spectral feature associated with hydrogen bonding in the sample.

78. The apparatus of claim 62 wherein the particle motion detector is positioned to detect scattering of light from the laser source in the sample

79. The apparatus of claim 62 wherein the apparatus comprises a further laser source and the particle motion detector is positioned to detect scattering of light from the further laser source in the sample.

80. A method of spectroscopic structure investigation of a sample that includes a dispersed chemical species in a liquid phase, the method comprising:
providing the sample;
providing marker particles in the sample;
illuminating the sample with a light source;
receiving light from the dispersed chemical species in the sample;
detecting, from the received light, a spectrum from the dispersed chemical species in the sample;
detecting movement of the marker particles in the sample; and
extracting at least one characteristic of the dispersed chemical species in the sample from both the step of detecting a spectrum and the step of detecting movement of the particles.

81. The method of claim 80, wherein:
i) illuminating the sample comprises exciting the sample,
receiving light comprises receiving Raman scattered light, and
the spectrum is a Raman spectrum; or
ii) wherein the spectrum is an infrared, near-infrared, far-infrared or a terahertz spectrum.
